(19) United States
(12) Patent Application Publication
(10) Pub. No.: US 2012/0101842 A1
(43) Pub. Date: Apr. 26, 2012

(54) System for High-Efficiency Instrument Sterilization

(75) Inventor: Robert M. Montano, Eagle, CO (US)

(73) Assignee: ADVANCED STERILE PROCESSING AND CONSULTING, LLC, Eagle, CO (US)

(21) Appl. No.: 13/279,078

(22) Filed: Oct. 21, 2011

Related U.S. Application Data
(60) Provisional application No. 61/405,867, filed on Oct. 22, 2010.

(51) Int. Cl. G06Q 50/22; G06Q 10/06

(52) U.S. Cl. 705/2

(57) ABSTRACT

The current inventive technology encompasses a system for high-efficiency instrument sterilization. Some embodiments may incorporate a computer implemented system for high efficiency instrument sterilization system for identifying, calculating and generating an optimal sterilization protocol by a software directed special purpose computing device and a novel software hardware interface. This inventive technology may be coordinated among various facilities to more efficiently manage a central sterilization facility servicing multiple health-care and other related facilities.

This application claims the benefit of and priority to U.S. Provisional Application No. 61/405,867 file Oct. 22, 2010. The entire specification and figures of the above-mentioned application is hereby incorporated, in its entirety by reference.

### TECHNICAL FIELD

Generally, the inventive technology disclosed herein relates to techniques, systems, methods and apparatus for high-efficiency instrument sterilization. More specifically, the inventive technology may involve methods, apparatus, techniques, and systems for the sterilization of medical instruments (instrumentation) for example in a hospital, veterinary hospital or laboratory and/or other sterile processing facility. The inventive technology may be particularly suited for mass, or bulk sterilization of surgical instruments, individual sterilization of surgical instruments, surgical tray preparation and/or optimization, hospital scheduling and/or management, medical office sterilizations operations, enhanced sterilization protocols, improved sterilization operations process management, surgical department operations and/or scheduling, improved disease and/or contamination prevention and patient management

In particular, certain embodiments for such a system(s) for high-efficiency instrument sterilization may include integrated software directed and/or hardware machine components that may directly and or indirectly transform particular elements of the inventive technology as will be detailed below. The current inventive technology provides numerous novel and commercially advantageous features including significant cost savings and labor resources; increases resource efficiency and allocation; increase inventory turnover; reduced overall instrument inventory requirements, improved instrument sterilization, integrated facility scheduling as well as operations management and the like.

### BACKGROUND OF THE INVENTION

The incidence and prevalence of nosocomial infections (i.e. are infections which are a result of treatment in a hospital or a healthcare service unit) is a serious problem facing modern healthcare. While precise statistics may be difficult to ascertain, the Center for Disease Control has reported that nosocomial infections have increase 36% over the last twenty years. It is believed that approximately 2 million people (or 1 in 10 hospitalized patients) every year contract a bacterial of other nosocomial in a hospital or other facility. Further, it is believed that approximately 88,000 Americans die every year from such preventable infections. This situation is aggravated by the rise of antibiotic resistance strains of bacteria, air and blood borne viruses as well as prion related diseases. In addition, as can naturally be understood, the problem of nosocomial infections is significantly more severe in other second and third world countries. Clearly there is a long felt need within the industry for advancements in the sterilization processes at these types of facilities.

One of the most significant ways that hospitals and other medical facilities have to combat nosocomial infections is through sterile processing techniques, systems and procedures. Generally, invasive surgical instruments used at such facilities must go through a series of decontamination and inspection steps prior to being sterilized and sealed. This is commonly done by a Sterilization Processing Department (SPD) located in the hospital or medical facility. While there are various industry standards for sterilization of invasive surgical instruments, there have been very little advancements in this field that have realized appreciable cost and/or saving benefits.

The foregoing problems regarding conventional instrument sterilization systems and processes may represent a long-felt need for an effective solution to the same. While implementing elements may have been available, actual attempts to meet this need may have been lacking to some degree. This may have been due to a failure of those having ordinary skill in the art to fully appreciate or understand the nature of the problems and challenges involved. As a result of this lack of understanding, attempts to meet these long-felt needs may have failed to effectively solve one or more of the problems or challenges here identified. These attempts may even have led away from the technical directions taken by the present inventive technology and may even result in the achievements of the present inventive technology being considered to some degree an unexpected result of the approach taken by some in the field.

As such, the current inventive technology provides a single comprehensive solution, which in some embodiments is expressed through integrating novel hardware and/or software directed solutions to facilitate the high-efficiency system for sterilization of instruments in a medical or other sterilization facility resulting in a significant savings of cost, time and/or other valuable resources while enhancing overall sterilization processes.

### SUMMARY OF THE INVENTION

Typically one aspect of any sterile processing department is the creation of surgical trays. In a typical conventional instrument sterilization system, any facility, such as a hospital surgical department that performs any type of invasive procedure will naturally require sterilized instruments. Generally, each tray is custom assembled to correspond to a specific surgical procedure. For example, if a surgeon will be performing a hip replacement he or she will require a specifically assembled tray with instruments necessary for that specific procedure. As can be naturally seen it may be very difficult to achieve an optimal level of coordination and communication between the needs of a surgical department and the sterile processing department that must custom assemble each trays.

Typically, tray assembly may include for example the discrete steps of: 1) instrument decontamination; 2) identifying the correct instrument (according to the specific tray being constructed and/or preference; 3) verifying the functionality of the instruments; 4) physical assembly of the tray so as to account for space and weight concerns for proper and sufficient sterilization; 5) placement of assembled tray in a container or wrapper prior to sterilization; and finally 6) sterilization and storage prior to use.

In some instances there exist common instruments that may be included in all or a majority of trays. Such common instruments are general basic instruments that would be used in a majority of invasive procedure. For example, in some instances a common instrument may include any instrument used in approximately 80%-90% of the assembled trays depending on the facility, practitioner and/or perhaps medical practice group. Augmenting such common instruments would be specific instruments. These instruments may be specific to a single or group of procedures, or even a doctor or facility preference. As can be seen, the amount of labor, inventory and associated cost to evaluate all of the tray needs for even a small medical facility is daunting to say the least. Tray or instrument tracking software known in the industry is wholly inadequate to provide any type or indication of an optimal tray configuration or even any cost saving or inventory allocation. Such software applications merely track the use and location of individual instruments and have been found to be largely ineffective outside of that limited tracking ability.

The current inventive technology, utilizing novel software directed and/or hardware systems, in some embodiment may accomplish broadly, but not be limited to some of all of the following:
Realize significant cost and time savings
Reduce tray weight
Optimize tray configuration
Identify and evaluate common, semi-common and/or specific instruments based on desired variables
Optimize tray orientation and/or placement for optimal sterilization
Optimize resource allocation
Optimize inventory allocation and use
Optimize tray instrument density and weight
Optimize tray sterilization requirements and sterilization profile according to a customized and or commons tray
Optimize instrument and sterilization turnover
Identify and optimize single pack instrument sterilization and inventory allocation
Improve tray and/or individual instrumentation sterilization profile or results
Coordinate and optimize hospital scheduling and surgical room operations
Increase SPD time and motion efficiency
Increase safety and reduce professional liability exposure
Generate cost savings reports and/or forecast
Multi-variable analysis and optimization
Hospital and/or operating room surgical tracking/scheduling software integration
Optimized tray transformation
Multi-facility sterilization procedure coordination and integration

Accordingly, the objects of the methods and apparatus for instrument sterilization described herein address each of the foregoing problems and goals in a practical manner. Naturally, further objects of the inventive technology will become apparent from the description and drawings below.

### BRIEF DESCRIPTION OF THE DRAWINGS

FIG. 1 is a flow chart diagram of a computer implemented system for high efficiency instrument sterilization in one embodiment thereof.

FIG. 2 is a flow chart diagram of a computer implemented system for multi-facility high efficiency instrument sterilization in one embodiment thereof.

### DETAILED DESCRIPTION OF THE INVENTIVE TECHNOLOGY

As mentioned earlier, the present invention includes a variety of aspects, which may be combined in different ways. The following descriptions are provided to list elements and describe some of the embodiments of the present invention. These elements are listed with initial embodiments, however it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

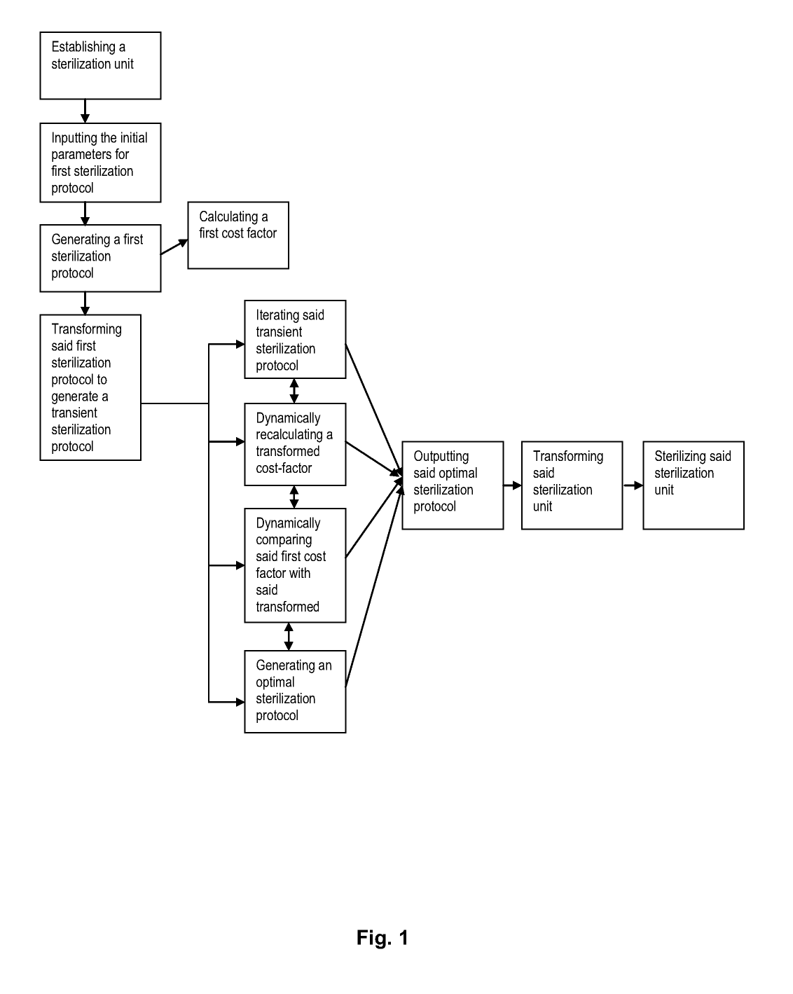

As referred to in FIG. 1, the inventive technology generally relates to computer directed techniques, systems, methods and apparatus for high-efficiency instrument sterilization. One preferred embodiment may include the steps of: establishing a sterilization unit; inputting initial parameters for a first sterilization protocol into a software directed special purpose computing device; generating a first sterilization protocol based on said initial parameters by a software directed special purpose computing device and further comprising the step of calculating a first cost factor for said first sterilization protocol; transforming said first sterilization protocol, by a software directed special purpose computing device, to generate a transient sterilization protocol further comprising the steps of iterating said transient sterilization protocol, by a software directed special purpose computing device; dynamically recalculating a transformed cost-factor, by a software directed special purpose computing device, for said transient sterilization protocol; dynamically comparing said first cost factor with said transformed cost-factor by a software directed special purpose computing device; generating an optimal sterilization protocol by a software directed special purpose computing device; outputting said optimal sterilization protocol by a software directed special purpose computing device; transforming said sterilization unit according to said optimal sterilization protocol; and sterilizing said sterilization unit according to said optimal sterilization protocol.

As shown in FIG. 1, one embodiment of the current inventive technology may include the step of establishing a sterilization unit. This step may include identifying an initial set of instruments to be sterilized. Such sterilization unit may be based on specific request or past historical use or perhaps by an industry standard, schedule based rotation or recommendation. This step of establishing a sterilization unit may include the discrete steps of deriving an individual instrument utilization profile. Such a profile may include a determination of the number and type of instruments needed for example in a particular invasive or non-invasive surgery as well as it's individual characteristics such as size, shape, deconstruction requirements, use, use history, sterilization requirements, special sterilization procedures and/or requirements, instrument surface area, as well as instrument prevalence and usage, both present and historical.

Additional embodiments may include deriving a common instrument profile, which may comprise the step of identifying instruments common to approximately at least 90%-80% of surgical instrument tray units for a specific facility, group, practice group or practitioner. Additional embodiments may include, establishing a semi-common instrument use profile, which may include the step of identifying instruments common to approximately at least 50% of surgical instrument tray units for a specific facility, group, practice group or practitioner. Additional embodiments may include deriving an individual instrument utilization profile the step of establishing a specific instrument use profile, which may include the step of identifying instruments common to approximately at least 10%-20% of surgical instrument tray units for a specific facility, group, practice group or practitioner. Additional embodiments may include deriving an individual instrument utilization profile the step of establishing a special instrument use profile, which may include the step of identifying instruments common to approximately at least 1%-10% of surgical instrument tray units for a specific facility, group, practice group or practitioner.

Such instruments and their corresponding profiles may be coded to facilitate further data and sterilization management procedures. Such coding may be tracked electronically perhaps with an identifying mark, RFID tag or other known inventory management system. Such coding may further identify the instruments classification as common, semi-common, specific and/or special as well as track their individual usage history. Such derivations may be based on historical usage, facility or individual practitioner preference and the like.

As generally seen in FIG. 1, one exemplary embodiment of the current inventive technology may encompass the step of inputting initial parameters for a first sterilization protocol into a software directed special purpose computing device. Such step of inputting may be performed by an operator which may be for example a sterilization department employee, facility employee or other requesting third party. Such first parameters may include, for example, surgical instrument units; invasive instrument tray units; common instruments; specific instruments; special instruments; procedure, time period for procedure, scheduling, doctor instrument preference, specific facility, practice group instrument preferences, aberrant parameters, sterilization cost per instrument; sterilization cost per unit; liability factor per procedure; liability factor per sterilization unit; liability factor per sterilization event; accrued costs; sterilization process used; and individual instrument sterilization profile.

Additional embodiments may include the step of inputting past instrument utilization profile(s). Such past instrument use profile may include individual use of an instrument as well as past historical use based on a facility or practitioner's preference. Such past instrument utilization profile may be linked to past surgical histories as each surgical procedure may correlate to a discrete set of instruments. A past instrument utilization profile may also include a designation of common, semi-common, specific as well as special instrument.

Further embodiments may include the step of inputting individual instrument orientation and/or configuration profile. In such an embodiment instrument orientation may include the desired specific instrument placement on for example an instrument tray prior to sterilization as well as the area that such orientation may occupy in order to be most effectively sterilized i.e. whether it need to be broken down or may remain assembled. Such information may be important as instruments that are too densely packed together during the sterilization process may not be adequately sterilized by the process. In such an embodiment, an instrument configuration profile may include the specific sterilization needs of the instrument, which may include instrument total surface area, unexposed surface area, as well as the number and type of joints, connections or other obstructions that may impede or hamper the sterilization process. In one example, an instrument with a large unexposed or obstructed surface area may resist heat and pressure penetration, perhaps from an autoclave, or chemical penetration from a gaseous sterilization procedure, requiring a longer and more intense sterilization process.

Further embodiments may include the step of inputting the individual instrument's weight profile. Such information may be important as a proposed sterilization unit may be too heavy for safe lifting and/or sterilization. Such individual instrument profiles may be used to help generate a first sterilization protocol based on said initial parameters by a software directed special purpose computing device as well as generating an optimal sterilization protocol by a software directed special purpose computing device as will be discussed later.

As generally seen in FIG. 1, one exemplary embodiment of the current inventive technology may include the step of inputting initial parameters for a first sterilization protocol into a software directed special purpose computing device. In some embodiments an operator may input initial cost parameters may include inputting initial cost factors selected from the group of consisting of: individual instrument cost; individual instrument sterilization costs; incremental instrument costs; incremental sterilization cost; instrument replacement cost; instrument depreciation; instrument utilization cost; sterilization utilization cost; labor cost; time in motion data; delay cost; materials cost; labor allocation costs; cost variables; cost multipliers; budget; cost forecasts; cost outlays; fixed cost; facility costs; inventory cost; and maintenance costs.

In addition, in certain embodiments it may be possible to enter information related to specific or general aberrants. Such aberrants may be individual aberrant costs or sensitivity factors that may alter said input elements and/or produce alterations of cost, time, and or saving. Such aberrants may include any extra or extraordinary cost and/or cost factor that may include or otherwise directly or indirectly alter the initial data set inputted and or outcomes. In some instances such aberrants may be tied to a specific condition—such as a fixed cost and/or other cost and/or savings factor that may exist at a specific locality and or facility. In addition, such aberrants may include and account for capacity, economies of scale, special one-time savings as well as variable individual personal and/or management costs, as well as those known and appreciated by those of ordinary skill in the art. In some embodiments an operator may perform the step of inputting aberrant factors selected from the group of consisting of: aberrant cost factors; aberrant cost multipliers; cost sensitivity factors; extraordinary costs; one-time costs; one-time cost factors; capacity costs; economies of scale factors; one-time savings; and one-time savings factors.

Evaluation of all initial parameters by a software directed special purpose computer may, as part of the step of generating said first sterilization protocol also perform the step of calculating a first cost factor for said first sterilization protocol utilizing all or some of the aforementioned initial parameters. It should be noted that that all such steps of inputting may be done through an appropriate graphical interface and or other data-entry system. Such system may also be automated in some instances. Typically hospitals or other medical and/or sterilization facilities do not possess such information, thus in some embodiments the current inventive technology may evaluate using a computer specifically programmed for such a purpose as sensitivity analysis of all or some of the variables as herein described. In some embodiments, such computer directed system may automatically determine, for example which instruments would be considered common, semi-common, specific and/or special as well as their frequency of use and or non-use as well as a cost factor associated with each individual instrument, and/or tray configuration as well as sterilization costs and the like. As can be seen, such embodiments may allow for the current inventive technology to be applied in various hospitals and or other mass sterilization facilities to evaluate and determine what instruments are initially selected for their various tray iterations and may be further analyzed and transformed so that such future tray iterations and overall sterilization efforts may be personalized to individual variables such as doctor and/or facility preference, procedure performed, liability factors, cost saving and/or past use history.

Additional embodiments of the step of generating of a first sterilization protocol, may include, for example, the step of generating a first surgical instrument tray unit with a first common and/or semi-common and/or specific, and/or special instrument profile. In this embodiment, the computer generated system may automatically, based on the inputted parameters generate instructions, whether written or graphically displayed for the set-up of a first surgical instrument tray unit. Further embodiments may include, generating a first surgical instrument tray orientation, and/or configuration, and/or weight profile. Such first protocols may be graphically displayed, as well as part of a generated report which for example may detail a first surgical instrument tray unit with a first common and/or semi-common and/or specific, and/or special instrument profile and first surgical instrument tray orientation, and/or configuration, and/or weight profile.

In addition such first sterilization protocol may include the step of generating a first sterilization profile, or instruction on the sterilization parameters for that individual tray. In some instances such a sterilization profile may include a first autoclave sterilization profile, which may automatically generate time, pressure and temperature, number of cycles and cool down instructions to an operator for the given individual sterilization unit or grouping of sterilization units. Similarly, such a sterilization profile may include the step of generating a first heat sterilization profile which may automatically provide time and temperature instructions, and/or a generating a first chemical sterilization profile, which may automatically generate, according to the type of chemical selected, exposure duration, concentration, and decontamination procedure and other special instructions.

Still further embodiments may similarly generate a first decontamination profile. Such a profile may provide instruction on the type, time, method and other special considerations of the necessary decontamination procedures needed for an individual instrument, sterilization unit or group of sterilization units. Such steps may include generating a chemical decontamination instrument profile; an enzymatic decontamination instrument profile; and a deconstruction decontamination instrument profile (or the special considerations that some instruments must be broken down to expose various surfaces for proper cleaning, decontamination and/or sterilization.). Similarly the inventive technology may encompass the step of generating a first instrument cleaning profile, a manual instrument cleaning profile, and a machine directed instrument cleaning profile.

The benefits of generating such profiles are clear, whether in a first or optimal sterilization/decontamination/cleaning protocol. In some instances, the inventive technology may be used to help train and manage new employees on proper as well as provide a fail-safe measure to provide an automated system to direct and manage a facilities sterilization and/or decontamination and/or cleaning protocols.

Referring generally to FIG. 1, the inventive technology may in some embodiments allow for the transforming said first sterilization protocol, by a software directed special purpose computing device, to generate a transient sterilization protocol. Such transient sterilization protocol may in some embodiment represent a number of individual intermediate or transient sterilization protocols as dictated by various permutations of applied parameters. Such intermediate or transient sterilization protocols may be dynamically created by the manipulation of various parameters herein described. Such manipulation may be directed effected by an operator, or perhaps through an automated process as directed by a desired cost or other sterilization protocol or parameter. In that sense, each parameter may be weighted and manipulated to achieve a desired cost and/or other sterilization protocol.

The current inventive technology allows for the inputted data to be transformed by a computer and/or other appropriate device, in some instances through an appropriate software and/or hardware application. As seen in FIG. 1, such transformative steps may, in some embodiments include the discrete sub-steps of iterating said transient sterilization protocol, by a software directed special purpose computing device; dynamically recalculating a transformed cost-factor, by a software directed special purpose computing device, for said transient sterilization protocol; dynamically comparing said first cost factor with said transformed cost-factor by a software directed special purpose computing device; and generating an optimal sterilization protocol by a software directed special purpose computing device.

It should be noted that in the current inventive technology, all such parameters may be dynamically linked, in that if one parameter is changes, all such parameters may likewise result in a changed output, such that any changes in any parameter will create a new iteration of a sterilization protocol in a dynamic process. One can easily appreciate that such a feature may be extremely beneficial as the inventive technology may allow various iterations to be proposed and evaluated by an operator or the computer directed system itself, arriving at various optimal sterilization protocol. In some instances such optimal sterilization protocol may be evaluated on cost, or perhaps inventory usage or availability, or even instrument weight and/or orientation and/or configuration. In other embodiments it may be possible to generate an optimal sterilization protocol based on sterilization resources and procedures. The time and cost savings as well as inherent adaptability of these aspects of the invention are clear.

As can be appreciated, such a step of sterilization protocol, tray and/or instrument iteration may have a direct and/or indirect effect on the previously outputted calculated cost factor. In such a manner, as show in FIG. 1, the system may re-calculate a cost factor to account for the new iteration. Such re-calculation may be repeated numerous times and may further be sequentially transformed and displayed and/or tracked through a visual and or graphical interface. In this manner the system is freely manipulable by an operator such that it is possible to compare and track the originally calculated cost factor with the new or re-calculated cost factor resulting from the transformation of the data through the inputting of various sterilization protocol iterations. In such a manner, as can be naturally seen, it may be possible for an operator, or the novel software and/or hardware solution to output an optimal tray configuration according to any of the variable parameters as herein described.

In some embodiments an iterated transient sterilization protocol is generated and displayed. Such a transient sterilization protocol may be visually displayed through a computer graphical interface and/or a physically generated hard-copy report along with all relevant inputted parameters. Such a transient sterilization protocol(s) may be associated with each individual instrument and/or procedure, or may be outputted to account for individual sterilization cycles. Further embodiments may account for cost of materials and/or inventory allocation as well as weight and instrument placement and orientation on said trays that may further physically affect the sterilization process. Such embodiments allow for dynamic sensitivity analysis, the results of which may further be physically displayed through a graphical interface. Such an interface may include individual icons that may represent for example individual instruments, tray configurations as well as any of the other variables as herein described.

Generally referring to FIG. 1, additional steps of transforming said first sterilization protocol, by a software directed special purpose computing device, to generate a transient sterilization protocol may include automatically altering initial inputted parameters to generate additional transient sterilization protocols, where the term automatically is meant to refer to a transformation executed by process of a software directed special purpose computing device. Additionally, an operator may also perform the step of inputting new parameters to generate additional said transient sterilization protocols according to a desired result or baseline. Indeed, an operator may input or delete various parameters to reach to desired baseline, such as a cost baseline, or a sterilization efficiency baseline, time based baseline or other resource utilization result.

In some embodiments, as referred to in FIG. 1, the step of transforming said first sterilization protocol, by a software directed special purpose computing device, to generate a transient sterilization protocol may include the step of dynamically comparing said first cost factor with said transformed cost-factor by a software directed special purpose computing device. Such transformed cost factor may be dynamically graphically and visually represented and compared with said originally calculated cost factor.

In some embodiments, the step of outputting an optimal configuration may include outputting a visual representation through a graphical interface of the specific optimal instruments for a specific tray configuration. In other instances, such step of outputting an optimal configuration may include transforming said data into a graphical display that can be imprinted in hard-copy form. As indicated in FIG. 1, such steps may be a computer controlled and/or software directed, and may further direct the physical transformation of individual trays or individual instruments per the outputted optimization. Further, such a system may generate a final cost saving output. Such a final cost savings output may be beneficial in that it may allow for a cost/efficacy analysis of the current system which can be transmitted real-time to any individual or third party or other appropriate data storage device.

In such an embodiment, an optimal tray configuration may be iterated and determined based on the variables as herein described and physically printed onto a sheet of paper or other appropriate material. Such imprint can be optimized so as to correspond to the size of a specific tray configuration and may further provide in some embodiments an outline of the instruments and their placements that are needed for that optimal configuration. In this regard, such a system may also account for the size and optimal placement of said instruments on a tray prior to sterilization. This provides numerous advantages. First, such a physical outline may provide significant time and labor savings as it will aid personnel in assembling an optimal tray configuration. This may be especially important when training new employees as it may be easier to appropriately match the proper instrument with the corresponding outline. Further, each outline may identify the exact instrument needed in a list form, or even be listed next to its outputted outline further reducing chance of error and reduce incidence of liability invoking mistakes and sterilization errors. In addition, as can be appreciated by those of ordinary skill in the art, such paper may in fact be any material that is able to perform the functions as herein described and may further be sterilized without significant adverse affects to the integrity of the process.

In addition, such a system, being able to account for the shape and geometric orientation of the instruments on an optimized tray, it may be possible for an operator to optimize a tray configuration based on weight and space concerns. Such a novel advancement allows for an operator to optimally space each individual instrument to ensure proper and sufficient sterilization. Instruments that are too close together, or trays that are configured with too much weight, in addition to being a safety concern when lifting, may not achieve a proper sterilization profile. Thus, the determination of an optimal tray configuration may allow for a more efficient and reliable sterilization transformation of such trays and accompanying instrument.

It should be noted that with regard to the current inventive technology, optimal tray configuration can mean or be determined by optimal cost, professional preference, inventory needs or restrictions, liability concerns, sterilization procedures and efficacy concerns, or any other quantifiable or qualitative measure and/or parameter as appreciated by those of skill in the art. For example, it may be possible to determine a specific hospitals optimal common tray as well as specific tray configurations based on procedure, past usage history, professional preference and the like. Further, as indicated in FIG. 1, such step of outputting an optimal configuration may be based on inputted general operational requirements of a facility such as a hospital, or may be determined on a scheduled based system. Such a scheduled based system may allow for the outputting of optimal tray and/or instrument configurations based on sterilization resources, seasonal differences, past usage histories, individual hourly, daily, weekly, monthly or even yearly surgical schedules.

Referring generally to FIG. 1, in some embodiments the step of transforming said first sterilization protocol, by a software directed special purpose computing device, to generate a transient sterilization protocol may include the step of generating an optimal sterilization protocol by a software directed special purpose computing device generating an optimal sterilization unit profile. In this instance an optimal sterilization protocol may be a desired sterilization protocol derived from the various iterations as altered by the manipulation of various parameters applied. In some instances, such an optimal sterilization protocol may include the step of generating an optimal surgical instrument tray unit with an optimal common and/or semi-common and/or specific, and/or special instrument profile based on the parameters utilized. Additional embodiments may include the step of generating an optimal surgical instrument tray orientation, and/or configuration, and/or weight profile, as well as generating an optimal sterilization profile for the individual sterilization unit of group of sterilization units. Such optimal sterilization profile may further include the discrete steps of generating an optimal autoclave sterilization profile, generating an optimal heat sterilization profile; generating an optimal chemical sterilization profile, generating an optimal decontamination profile, and/or generating an optimal instrument cleaning profile.

In some embodiments such optimal sterilization protocol and/or profiles may be outputted in a graphical display. In still further, such optimal sterilization protocol and or profiles may be imprinted a hard copy of for example paper or other appropriate material that could be sterilized along with the sterilization unit such that the imprinted hard-copy of said optimal sterilization protocol and or profiles may represent a surgical tray overlay with a visible outline of said optimal instrument selection and/or configuration and/or orientation and/or weight. Such an embodiment would have the advantage, especially for new or untrained sterilization professionals in showing the exact placement, orientation, deconstructed profile, as well as configuration of each surgical tray prior to sterilization. Such surgical tray overlay would provide optimal sterilization profile at an optimally calculated cost providing obvious benefits to the user.

Additional embodiments may allow for said step of generating an optimal sterilization protocol by a software directed special purpose computing device to be integrated into a facilities schedule based software or other system, such as a hospitals surgical schedule system and generate a schedule based sterilization protocol. Additionally such optimal sterilization protocol may be based on various facility generated parameters to include a procedure schedule sterilization protocol; a historical procedure schedule sterilization protocol; a seasonal sterilization protocol; a past instrument usage sterilization protocol; an hourly sterilization protocol; a daily sterilization protocol, a weekly sterilization protocol; a monthly sterilization protocol; a yearly sterilization protocol.

In some embodiments, it may occur that a desired set of parameter may result in certain sterilization protocol iterations, and even optimal sterilization protocols that may conform to, for example, cost optimization but may result in a sterilization unit that will be inappropriate for sterilization. Such instances may be due to excess weight, incompatible instrument configuration and/or orientation resulting in insufficient sterilization profile, or perhaps a sterilization profile that falls below an established threshold. In that instance, one embodiment of the current inventive technology may include the step of outputting a sterilization protocol deficiency warning indication to alert an operator of such deficiency or error. Such indication may be any visual or audible indication that can alert an operator to such deficiency and even provide corrective or remedial measures and/or instructions. Additional embodiments may include outputting a sterilization protocol instrument orientation and/or configuration incompatibility indication as well as a specific sterilization protocol threshold weight limit warning indication.

As seen generally in FIG. 1, once an optimal sterilization protocol has been established, the system may further output said optimal sterilization protocol by a software directed special purpose computing device. Such optimal sterilization protocol may be transmitted over the internet, to a data storage apparatus, or in some cases to a facility system such as a hospital surgical procedure scheduling system, or it may be transmitted to a sterilization facility from the originating facility such as a hospital. In some embodiments, such outputting step may be accomplished by the novel software and/or hardware solutions described herein that may be integrated with and/or communicate with a facilities general software or network. In one example, such an embodiment may include a communication link between the scheduling software being used in a particular hospital surgical department. As such, as various invasive surgeries or other procedures requiring sterilized instrumentation are required, such requirements may be automatically transmitted, perhaps through the internet or other appropriate network or transmission device and automatically generate an optimal tray configuration based on a desired or pre-determined set of variables and directed to the appropriate on- or off-site sterilization facility. Such an embodiment may allow for a significant reduction in labor and sterilization cost, but will more efficiently allocate inventory and resources as well as provide superior sterile instrumentation needed by surgical department or other facilities.

Generally referring to FIG. 1, certain embodiments of the current inventive technology may include the step of transforming said sterilization unit according to said optimal sterilization protocol. Such step may include the physical selection, assembly, creation and distribution of sterilization units and or other individual instruments onto for example a surgical tray according to the outputted sterilization protocol. In some instances such a system may be automated, and performed automatically such that it is performed by an automated computer directed process. Such embodiments may include the automatic transformation of an optimal common and/or semi-common and/or specific and/or special instrument selection, optimal instrument orientation and configuration, optimal sterilization protocol based a selected parameter, optimal sterilization protocol based a selected cost parameter, optimal sterilization protocol based a selected sterilization parameter, and/or optimal sterilization protocol based a selected aberrant parameter.

In some instances such transformation of a sterilization unit may be manually transformed, perhaps as directed by the computer generated optimal sterilization protocol. Such transformation may include transforming said sterilization unit according to said optimal sterilization protocol to establish common and/or semi-common and/or specific and/or special instrument sterilization protocol, transforming said sterilization unit according to said optimal sterilization protocol to establish a hybrid (or mix of instrument types) instrument sterilization protocol; transforming said sterilization unit according to said optimal sterilization protocol to establish a optimal instrument orientation and configuration sterilization protocol, and/or transforming said sterilization unit according to said optimal sterilization protocol to establish a optimal instrument weight sterilization protocol.

Again referring to FIG. 1, after the transformation of a sterilization unit, perhaps into an optimal surgical tray profile with an associated optimal sterilization profile, said sterilization unit may be sterilized by the appropriate method according to said optimal sterilization protocol, which may include, but not be limited to: autoclave sterilizing, heat sterilizing and/or chemical sterilizing. Such sterilized units may them be stored for appropriate use as scheduled or desired. As one can see, it may be possible, based on parameter such as historical use, as well as cost and schedule based parameters and aberrants, to generate an optimal sterilization protocol to pre-generate common, semi-common, specific and/or special instruments in a frequency related to their use in the most cost efficient manner. In this way, the current inventive technology may provide a useful solution to maintain appropriate inventories of sterilized instruments in a cost efficient manner while allowing the maximum flexibility to provide various sterilization units to a single or multiple facilities.

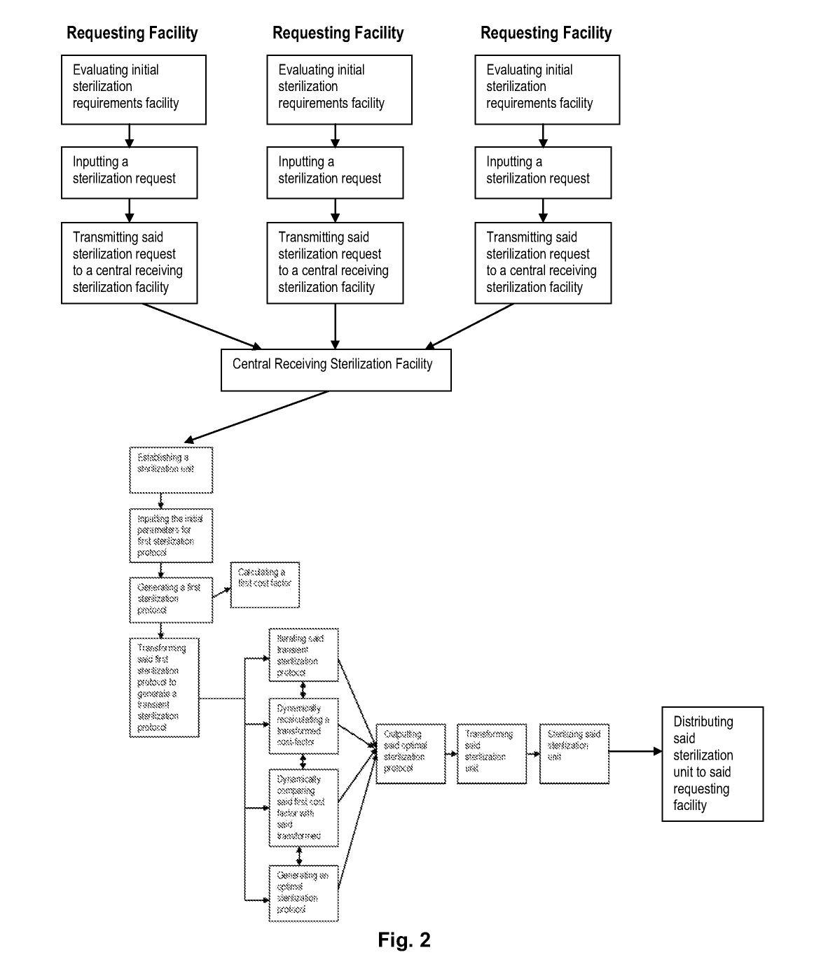

As seen in FIG. 2, other embodiments may include the steps of evaluating initial sterilization requirements for at least one requesting facility and inputting a sterilization request into a software directed special purpose computing device for at least one facility. This inputted request may then transmit to said sterilization request to a central receiving sterilization facility for processing. In some embodiments this may be accomplished by a network communication that links various hospitals or other facilities with a single sterilization facility allowing for example multiple hospitals to coordinate their sterilization needs. In such an embodiment, a single facility may be able to simultaneous provide individual optimized sterilization protocols and cost saving estimates for multiple facilities in a real-time and instantaneous manner. Such a system, as herein described as can be readily seen and may be easily adapted to provide tray and instrument tracking, as well as allocation resources for various facilities based on general or scheduled needs. In still further embodiments, such a system may be located at a single or distinct site and coordinate the various actions as herein described through an appropriate network communication device. For example, multiple facilities may be functionally linked through the current inventive technology and may input general or scheduled sterilization parameters into their hospital or surgical department scheduling software, which are then transmitted to a central processing location, which in turn derives an optimal sterilization protocol and transmits back the appropriate optimal sterilization protocol and associated costs. Such central location can transmit directly to a hospital SPD or other facility perhaps through the internet or other appropriate transmission element.

Additionally, as can be deduced, the current inventive technology may be extended to not only include invasive surgical instruments but non-invasive surgical instruments and/or other materials that require sterilization, as well as any appropriate item that could be sterilized. As such, the implementation of the current inventive system may have a wide range of applications across various industries. In fact, the current inventive technology may in fact be adapted and integrated into any process and/or system that require any physical assets to be assembled, customized, transformed, and/or modified and the like.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the statements of invention. As can be easily understood from the foregoing, the basic concepts of the present invention may be embodied in a variety of ways. It involves both techniques as well as devices to accomplish the appropriate system for high-efficiency instrument sterilization and the like. In this application, the instrument sterilization techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in method-oriented terminology, each element of the claims corresponds to a device. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting any claims. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “sterilization” should be understood to encompass disclosure of the act of “sterilizing”—whether explicitly discussed or not—and, conversely, were there effectively disclosure of the act of “sterilizing”, such a disclosure should be understood to encompass disclosure of a “sterilization method and/or technique, and or device” and even a “means for sterilizing”. Such changes and alternative terms are to be understood to be explicitly included in the description.

Any patents, publications, or other references mentioned in this application for patent are hereby incorporated herein by reference in their entirety. Any priority case(s) claimed by this application is hereby appended and hereby incorporated herein by reference in their entirety. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated herein by reference in their entirety. Finally, all references listed in the list of References To Be Incorporated By Reference In Accordance With The Patent Application or other information disclosure statement and the like filed with the application are hereby appended and hereby incorporated herein by reference in their entirety, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the system (with corresponding methods and apparatus) of high-efficiency instrument sterilization as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

In addition and as to computer aspects and each aspect amenable to programming or other electronic automation, the applicant(s) should be understood to have support to claim and make a statement of invention to at least: xvi) processes performed with the aid of or on a computer and or controller as described throughout the above discussion, xv) a programmable apparatus as described throughout the above discussion, xvi) a computer readable memory encoded with data to direct a computer comprising means or elements which function as described throughout the above discussion, xvii) a computer configured as herein disclosed and described, xviii) individual or combined subroutines and programs as herein disclosed and described, xix) the related methods disclosed and described, xx) similar, equivalent, and even implicit variations of each of these systems and methods, xxi) those alternative designs which accomplish each of the functions shown as are disclosed and described, xxii) those alternative designs and methods which accomplish each of the functions shown as are implicit to accomplish that which is disclosed and described, xxiii) each feature, component, and step shown as separate and independent inventions, and xxiv) the various combinations and permutations of each of the above.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 715 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The inventive subject matter is to include, but certainly not be limited as, a system substantially as herein described with reference to any one or more of the Figures and Description (including the following: for example, the process according to any claims and further comprising any of the steps as shown in any Figures, separately, in any combination or permutation).

What is claimed is:

1. A computer implemented system for high efficiency instrument sterilization comprising the steps of:
establishing a sterilization unit;
inputting initial parameters for a first sterilization protocol into a software directed special purpose computing device;
generating a first sterilization protocol based on said initial parameters by a software directed special purpose computing device and further comprising the step of:
calculating a first cost factor for said first sterilization protocol;
transforming said first sterilization protocol, by a software directed special purpose computing device, to generate a transient sterilization protocol further comprising the steps of:
iterating said transient sterilization protocol, by a software directed special purpose computing device;
dynamically recalculating a transformed cost-factor, by a software directed special purpose computing device, for said transient sterilization protocol;
dynamically comparing said first cost factor with said transformed cost-factor by a software directed special purpose computing device;
generating an optimal sterilization protocol by a software directed special purpose computing device;
outputting said optimal sterilization protocol by a software directed special purpose computing device;
transforming said sterilization unit according to said optimal sterilization protocol; and
sterilizing said sterilization unit according to said optimal sterilization protocol.

2. A computer implemented system for high efficiency instrument sterilization as described in claim 1 wherein said step of establishing a sterilization unit comprises the step of establishing a surgical instrument unit.

3. A computer implemented system for high efficiency instrument sterilization as described in claim 2 wherein said step of establishing a surgical instrument unit comprises the step of establishing a surgical instrument tray unit.

4. A computer implemented system for high efficiency instrument sterilization as described in claim 3 wherein said step of establishing a surgical instrument tray unit comprises the step of deriving an individual instrument utilization profile.

5. A computer implemented system for high efficiency instrument sterilization as described in claim 4 wherein said step of deriving an individual instrument utilization profile the step of establishing a common instrument profile.

6. (canceled)

7. A computer implemented system for high efficiency instrument sterilization as described in claim 4 wherein said step of deriving an individual instrument utilization profile the step of establishing a semi-common instrument use profile.

8. (canceled)

9. A computer implemented system for high efficiency instrument sterilization as described in claim 4 wherein said step of deriving an individual instrument utilization profile the step of establishing a specific instrument use profile.

10. (canceled)

11. A computer implemented system for high efficiency instrument sterilization as described in claim 4 wherein said step of deriving an individual instrument utilization profile the step of establishing a special instrument use profile.

12-13. (canceled)

14. A computer implemented system for high efficiency instrument sterilization as described in claim 1 wherein said step of inputting initial parameters for a first sterilization protocol into a software directed special purpose computing device comprises the step of inputting initial parameters selected from the group of consisting of: surgical instrument units; invasive instrument tray units; common instruments; specific instruments; special instruments; procedure, time period for procedure, scheduling, doctor instrument preference, specific facility, practice group instrument preferences, aberrant parameters, sterilization cost per instrument; sterilization cost per unit; liability factor per procedure; liability factor per sterilization unit; liability factor per sterilization event; accrued costs; sterilization process used; and individual instrument sterilization profile.

15. A computer implemented system for high efficiency instrument sterilization as described in claim 1 wherein said step of inputting initial parameters for a first sterilization protocol into a software directed special purpose computing device comprises the step of inputting initial cost factors selected from the group of consisting of: individual instrument cost; individual instrument sterilization costs; incremental instrument costs; incremental sterilization cost; instrument replacement cost; instrument depreciation; instrument utilization cost; sterilization utilization cost; labor cost; time in motion data; delay cost; materials cost; labor allocation costs; cost variables; cost multipliers; budget; cost forecasts; cost outlays; fixed cost; facility costs; inventory cost; and maintenance costs.

16. A computer implemented system for high efficiency instrument sterilization as described in claim 1 wherein said step of inputting initial parameters for a first sterilization protocol into a software directed special purpose computing device comprises the step of inputting aberrant factors selected from the group of consisting of: aberrant cost factors; aberrant cost multipliers; cost sensitivity factors; extraordinary costs; one-time costs; one-time cost factors; capacity costs; economies of scale factors; one-time savings; and one-time savings factors.

17-19. (canceled)

20. A computer implemented system for high efficiency instrument sterilization as described in claim 1 wherein said step of generating a first sterilization protocol based on said initial parameters by a software directed special purpose computing device comprises the step of generating a first sterilization unit profile.

21. A computer implemented system for high efficiency instrument sterilization as described in claim 20 wherein said step of generating a first sterilization unit profile comprises the step of generating a first surgical instrument tray unit with a first common and/or semi-common and/or specific, and/or special instrument profile.

22-24. (canceled)

25. A computer implemented system for high efficiency instrument sterilization as described in claim 1 wherein said step of generating a first sterilization protocol based on said initial parameters by a software directed special purpose computing device comprises the step of generating a first sterilization profile.

26-34. (canceled)

35. A computer implemented system for high efficiency instrument sterilization as described in claim 1 wherein said step of transforming said first sterilization protocol, by a software directed special purpose computing device, to generate a transient sterilization protocol comprises the step of dynamically altering said inputted parameters.

36-45. (canceled)

46. A computer implemented system for high efficiency instrument sterilization as described in claim 1 wherein said step of dynamically recalculating a transformed cost-factor, by a software directed special purpose computing device, for said transient sterilization protocol comprises the step of dynamically recalculating said inputted parameters to reach to desired baseline.

47-55. (canceled)

56. A computer implemented system for high efficiency instrument sterilization as described in claim 1 wherein said step of generating an optimal sterilization protocol by a software directed special purpose computing device comprises the step of generating a schedule based sterilization protocol selected from the group consisting of: a procedure schedule sterilization protocol; a historical procedure schedule sterilization protocol; a seasonal sterilization protocol; a past instrument usage sterilization protocol; an hourly sterilization protocol; a daily sterilization protocol, a weekly sterilization protocol; a monthly sterilization protocol; a yearly sterilization protocol.

57. A computer implemented system for high efficiency instrument sterilization as described in claim 1 wherein said step of generating an optimal sterilization protocol by a software directed special purpose computing device comprises the step of outputting a sterilization protocol deficiency warning indication.

58-59. (canceled)

60. A computer implemented system for high efficiency instrument sterilization as described in claim 1 wherein said step of generating an optimal sterilization protocol by a software directed special purpose computing device comprises the step of generating an optimal sterilization unit profile.

61. A computer implemented system for high efficiency instrument sterilization as described in claim 60 wherein said step of step of generating an optimal sterilization unit profile comprises the step of generating an optimal surgical instrument tray unit with an optimal common and/or semi-common and/or specific, and/or special instrument profile.

62. A computer implemented system for high efficiency instrument sterilization as described in claim 60 wherein said step of generating an optimal sterilization unit profile comprises the step of generating an optimal surgical instrument tray orientation, and/or configuration, and/or weight profile.

63-64. (canceled)

65. A computer implemented system for high efficiency instrument sterilization as described in claim 1 wherein said step of generating an optimal sterilization protocol by a software directed special purpose computing device the step of generating an optimal sterilization profile.

66-73. (canceled)

74. A computer implemented system for high efficiency instrument sterilization as described in claim 1 wherein said step of outputting said optimal sterilization protocol by a software directed special purpose computing device comprises the step of imprinting a hard copy of said optimal sterilization protocol.

75. A computer implemented system for high efficiency instrument sterilization as described in claim 74 wherein said step of imprinting a hard copy of said optimal sterilization protocol comprises the step of imprinting a hard copy of said optimal surgical tray overlay with a visible outline of said optimal instrument selection and/or configuration and/or orientation and/or weight.

76-81. (canceled)

82. A computer implemented system for high efficiency instrument sterilization as described in claim 1 wherein said step of transforming said sterilization unit according to said optimal sterilization protocol comprises the step of automatically computer directed transforming said sterilization unit according to said optimal sterilization protocol to establish the optimal common and/or semi-common and/or specific and/or special instrument selection.

83. A computer implemented system for high efficiency instrument sterilization as described in claim 82 wherein said step of automatically computer directed transforming said sterilization unit according to said optimal sterilization protocol to establish the optimal common and/or semi-common and/or specific and/or special instrument content comprises the step of automatically computer directed transforming said sterilization unit to establish optimal instrument orientation and configuration.

84-98. (canceled)

99. A computer implemented system for multi-facility high efficiency instrument sterilization comprising the steps of:
evaluating initial sterilization requirements for at least one requesting facility;
inputting a sterilization request into a software directed special purpose computing device for at least one facility;
transmitting said sterilization request to a central receiving sterilization facility;
establishing a sterilization unit based on said sterilization request;
inputting initial parameters for a first sterilization protocol into a software directed special purpose computing device;
generating a first sterilization protocol based on said initial parameters by a software directed special purpose computing device and further comprising the step of:
calculating a first cost factor for said first sterilization protocol;
transforming said first sterilization protocol, by a software directed special purpose computing device, to generate a transient sterilization protocol further comprising the steps of:
iterating said transient sterilization protocol, by a software directed special purpose computing device;
dynamically recalculating a transformed cost-factor, by a software directed special purpose computing device, for said transient sterilization protocol;
dynamically comparing said first cost factor with said transformed cost-factor by a software directed special purpose computing device;
generating an optimal sterilization protocol for said requesting facility by a software directed special purpose computing device;
outputting said optimal sterilization protocol by a software directed special purpose computing device to at least one facility;
transforming said sterilization unit according to said optimal sterilization protocol;
sterilizing said sterilization unit according to said optimal sterilization protocol; and
distributing said sterilization unit to said requesting facility.

100-131. (canceled)

132. A computer implemented system for high efficiency sterilization comprising the steps of:
establishing a sterilization unit;
inputting initial parameters for a first sterilization protocol into a software directed special purpose computing device;
generating a first sterilization protocol based on said initial parameters by a software directed special purpose computing device;
transforming said first sterilization protocol, by a software directed special purpose computing device, to generate a transient sterilization protocol;
generating an optimal sterilization protocol by a software directed special purpose computing device; and
transforming said sterilization unit according to said optimal sterilization protocol.
